(19) United States
(12) Patent Application Publication
(10) Pub. No.: US 2021/0094715 A1
(43) Pub. Date: Apr. 1, 2021

(54) FULL-AUTOMATIC PRODUCTION LINE FOR MOXA-MOXIBUSTION STRIPS

(71) Applicant: HUAIYIN INSTITUTE OF TECHNOLOGY, Huaian (CN)

(72) Inventors: Tongyue WANG, Huaian (CN); Xiao LIAO, Huaian (CN); Long CHEN, Huaian (CN); Jian WANG, Huaian (CN); Zhaomei XU, Huaian (CN); Suqun CHAO, Huaian (CN); Zhong CHEN, Huaian (CN); Yuqing LIU, Huaian (CN); Jianxun XUE, Huaian (CN); Xiaodong GUO, Huaian (CN)

(21) Appl. No.: 16/981,647

(22) PCT Filed: Dec. 20, 2018
(86) PCT No.: PCT/CN2018/122400

§ 371 Date: Sep. 16, 2020

(30) Foreign Application Priority Data
Nov. 16, 2018 (CN) 201811366915.9

(51) Int. Cl. B65B 35/36; A61H 39/06; B65B 35/44

(52) U.S. Cl. CPC B65B 35/36; A61H 2201/0207; B65B 35/44; A61H 39/06

(57) ABSTRACT

The present invention discloses a full-automatic production line for moxa-moxibustion strips, sequentially including a strip extruder, a sectioning device, a wrapping device, a cutting device, a base mounting device, and a discharging conveying device, where the sectioning device is disposed at the tail end of an extrusion tube of the strip extruder and is connected to rotating clamp plates A by a transfer conveying device, the rotating clamp plates A pass the wrapping device and are then connected to a rotating clamp plate B, the rotating clamp plate B passes the cutting device and is then connected to rotating clamp plates C, and the rotating clamp plates C sequentially pass the base mounting device and the discharging conveying device. It can be known from the structure above that the full-automatic production line for moxa-moxibustion strips of the present invention implements automated production of extruding, sectioning, wrapping, base mounting and discharging of moxa-moxibustion strips, and improves the production efficiency while ensuring the production quality.

### TECHNICAL FIELD

The present invention relates to the technical field of automated production of moxa-moxibustion strips, and in particular, to a full-automatic production line for moxa-moxibustion strips.

### BACKGROUND

Moxa-moxibustion strips are moxa strips special for moxa-moxibustion. Moxa-moxibustion is one of the oldest medical techniques in China, and is an external treatment of traditional Chinese medicine. Warming moxibustion health preservation indicates that a special moxa-moxibustion strip is made from mugwort, the king of herbs, is ignited, and then placed in a warming moxibustion device and rolled around meridians and collaterals or affected parts, so as to comprehensively warm and dredge meridians and collaterals, warm and nourish vigor, reconcile qi and blood, and moisturize complexion for the human body to exude a healthy look.

At present, there is a specialized moxa-moxibustion strip extruder on the market. The specialized moxa-moxibustion strip extruder mixes mugwort and other important ingredients, then extrudes the mixture into a strip, and then cuts the strip into sections. Next, one end of each moxa-moxibustion strip which is a section obtained by the cutting needs to be wrapped and then fixed to a moxa-moxibustion strip base. However, the wrapping device for the moxa-moxibustion strip is independent, no specialized equipment is used for the fixing process step of the moxa-moxibustion strip and the moxa-moxibustion strip base, and the moxa-moxibustion strip that has been coated with glue by a gluing machine needs to be manually mounted to the moxa-moxibustion strip base by an operator, resulting in low production efficiency; moreover, the moxa-moxibustion strip is transferred among production equipment by means of a transfer vehicle, resulting in damage to the moxa-moxibustion strip during the transfer process and increasing production costs.

### SUMMARY

The purpose of the present invention is to overcome the shortcomings of the prior art, and provide a full-automatic production line for moxa-moxibustion strips, implementing automated production of extruding, sectioning, wrapping, base mounting and discharging of moxa-moxibustion strips, and improving the production efficiency while ensuring the production quality. A material holder is simple in structure, and by means of the function of the material holder, the drop height difference of moxa-moxibustion strip sections is reduced, the moxa-moxibustion strip sections are prevented from being damaged during dropping after sectioning, moreover, the moxa-moxibustion strip sections in the material holder can be automatically transferred to a conveying belt A for convenience of subsequent production of moxa-moxibustion strips. By means of the function of moxa-moxibustion strip cells disposed on the conveying belt, the moxa-moxibustion strip sections are prevented from random rolling during the conveyance of the conveying belt A, thereby ensuring that rotating clamp plates A can clamp the moxa-moxibustion strip sections placed on the conveying belt A. Two ends of the moxa-moxibustion strip section are clamped by the rotating clamp plates A, so as to facilitate wrapping the moxa-moxibustion strip section by the wrapping device. By means of the function of a rotating clamp plate B, a wrapping part of the moxa-moxibustion strip section is clamped, which can not only continue to apply an action force on the wrapping part, thereby improving the wrapping and fixing effect of the wrapping part and the moxa-moxibustion strip section, but also the clamping position of the rotating clamp plate B is close to two sides of a cutting device, ensuring that a saw blade does not damage other parts of the moxa-moxibustion strip section, and ensuring the quality of sawing. The automated mounting of the moxa-moxibustion strips to bases is implemented by a base mounting device, which not only improves the production efficiency, but also ensures the mounting quality of the moxa-moxibustion strips to the bases.

The technical solution adopted by the present invention is:

a full-automatic production line for moxa-moxibustion strips, sequentially including a strip extruder, a sectioning device, a wrapping device, a cutting device, a base mounting device, and a discharging conveying device, where the sectioning device is disposed at the tail end of an extrusion tube of the strip extruder and is connected to rotating clamp plates A by a transfer conveying device, the rotating clamp plates A pass the wrapping device and are then connected to a rotating clamp plate B, the rotating clamp plate B passes the cutting device and is then connected to rotating clamp plates C, and the rotating clamp plates C sequentially pass the base mounting device and the discharging conveying device.

A further improved solution of the present invention is that the edge of a feeding port of the strip extruder is provided with a flaring material guide surrounding wall.

A still further improved solution of the present invention is that the sectioning device includes an “n”-shaped support, the extrusion tube is located within the range of the “n”-shaped support, and cutters for cutting a strip extruded from the extrusion tube are movably connected to the inner side of the “n”-shaped support at positions corresponding to the extrusion tube.

A still further improved solution of the present invention is that there are two cutters, which are respectively located on two sides of the extrusion tube, and the planes where the opposite end surfaces of the two cutters are located are a same plane.

A still further improved solution of the present invention is that the transfer conveying device sequentially includes a material holder disposed along the direction of the extrusion tube and a conveying belt A, the material holder is located on a side of the sectioning device facing away from the strip extruder and the material holder is located below the extrusion tube, and the material holder is connected to the rotating clamp plates A by the conveying belt A.

A still further improved solution of the present invention is that the cross section of the material holder is a “V”-shaped structure having an upward opening, an end surface of a side of the material holder facing the conveying belt A is connected to a piston rod A of a lifting piston A, the material holder is connected to the piston rod A swingably around a horizontal rotating shaft A, a side of the lifting piston A facing away from the conveying belt A is further provided with a limiting vertical plate, and a side of the piston rod A facing away from the conveying belt A is provided with a limiting block.

A still further improved solution of the present invention is that: when the piston rod A drives the material holder to move downward until the material holder is in contact with the limiting vertical plate, as the piston rod A drives the material holder to continue descending, because the limiting vertical plate limits the position of the material holder on the side of the lifting piston A facing away from the conveying belt A, the material holder is turned toward a direction facing the conveying belt A; when the piston rod A drives the material holder to move upward, because the center of gravity of the material holder is on the side of the lifting piston A facing away from the conveying belt A, the material holder is turned toward a direction facing away from the conveying belt A; and when the material holder is driven by the piston rod A to rise to be separated from the limiting vertical plate, the material holder is in contact with the limiting block, and the material holder is kept horizontal in this case.

A still further improved solution of the present invention is that the conveying belt A is driven by horizontal transmission rollers, two ends of each transmission roller are respectively rotatably connected to racks A, a plurality of vertical bars are uniformly distributed on an outer surface of the conveying belt A, the vertical bars are arranged in a direction parallel to the extrusion tube, a moxa-moxibustion strip cell is formed between two adjacent vertical bars and the width of the moxa-moxibustion strip cell is greater than or equal to the diameter of a moxa-moxibustion strip extruded from the extrusion tube, and the width of the conveying belt A is less than the length of a moxa-moxibustion strip section obtained after sectioning by the sectioning device.

A still further improved solution of the present invention is that a driving motor A drives the transmission roller, and the driving motor A is fixed to the rack A.

A still further improved solution of the present invention is that “L”-shaped supports disposed outwardly are respectively fixed to the tops of the racks A on a side of the conveying belt A away from the material holder, a cross rod of each “L”-shaped support is located at the lower portion and fixed to the rack A, the inner sides of the upper ends of vertical rods of the “L”-shaped supports are connected by a horizontal rotating shaft B, the horizontal rotating shaft B is rotatably connected to the “L”-shaped supports, the rotating clamp plates A are respectively fixed to two ends of the horizontal rotating shaft B and located on the inner sides of the “L”-shaped supports, a plurality of clamping blocks are respectively correspondingly disposed on opposite side end surfaces of the rotating clamp plates A, the clamping blocks are uniformly distributed with the horizontal rotating shaft B as a center and the clamping blocks are respectively rotatably connected to the respective rotating clamp plates A, the clamping blocks on one of the rotating clamp plates A are respectively fixed to output shafts of driving motors M, the driving motors M are fixed on an outer end surface of the rotating clamp plate A, and the clamping blocks on the other of the rotating clamp plates A are rotatably connected to end portions of piston rods B of clamping pistons A.

A still further improved solution of the present invention is that: when the piston rod B retracts into the clamping piston A by a maximum stroke, the spacing between the clamping block on the piston rod B and the corresponding clamping block on the other rotating clamp plate A is greater than the length of the moxa-moxibustion strip section obtained after sectioning by the sectioning device, and the clamp blocks are respectively located outside the two ends of the moxa-moxibustion strip section conveyed on the conveying belt A; when the piston rod B extends out of the clamping piston A by the maximum stroke, the spacing between the clamping block on the piston rod B and the corresponding clamping block on the other rotating clamp plate A is less than the length of the moxa-moxibustion strip section obtained after sectioning by the sectioning device.

A still further improved solution of the present invention is that the horizontal rotating shaft B is driven by a driving motor B. and the driving motor B is fixed on the “L”-shaped support.

A still further improved solution of the present invention is that: the wrapping device is located above a position between the two rotating clamp plates A by means of a rack B and is located at a midpoint position of the moxa-moxibustion strip section clamped between the corresponding clamping blocks; when any group of corresponding clamping blocks rotate to a corresponding position of the wrapping device, another group of corresponding clamping blocks match the moxa-moxibustion strip cells on the upper surface of the conveying belt A in height, and the group of corresponding clamping blocks matching the moxa-moxibustion strip cells in height are located within the ascending stroke range of the rotating clamp plates A.

A still further improved solution of the present invention is that the rack B is of an “n”-shaped structure, the wrapping device is fixed on a cross rod of the rack B, vertical rods of the rack B are respectively disposed on two sides of the conveying belt A, and the vertical rods of the rack B are located outside the moxa-moxibustion strip section conveyed on the conveying belt A.

A still further improved solution of the present invention is that the rotating clamp plate B is rotatably connected to racks C by a horizontal rotating shaft C, a plurality of moxa-moxibustion strip clamp groups are uniformly distributed on the circumferential surface of the rotating clamp plate B, each moxa-moxibustion strip clamp group includes two moxa-moxibustion strip clamps A arranged side by side in the direction of the axis center of the horizontal rotating shaft C, a gap exists between the two moxa-moxibustion strip clamps A, the moxa-moxibustion strip clamp A includes a fixed clamping sheet A and a movable clamping sheet A, the fixed clamping sheet A is fixed to the rotating clamp plate B, the movable clamping sheet A reciprocates in a direction facing or facing away from the fixed clamping sheet A by a clamping piston B, and the clamping piston B is fixed to the rotating clamp plate B.

A still further improved solution of the present invention is that an end surface of the fixed clamping sheet A facing the movable clamping sheet A and an end surface of the movable clamping sheet A facing the fixed clamping sheet A are respectively provided with arc-surfaced grooves A, and when the movable clamping sheet A is attached to the fixed clamping sheet A under the action of the clamping piston B, the arc-surfaced groove A of the fixed clamping sheet A and the arc-surfaced groove A of the movable clamping sheet A constitute a through hole A matching a wrapping part on the surface of the moxa-moxibustion strip.

A still further improved solution of the present invention is that the horizontal rotating shaft C is driven by a driving motor C, and the driving motor C is fixed on the rack C.

A still further improved solution of the present invention is that: the cutting device is located above a side of the rotating clamp plate B facing away from the rotating clamp plates A, the cutting device includes a saw blade, the saw blade is fixed to the middle of a horizontal rotating shaft D, two ends of the horizontal rotating shaft D are respectively rotatably connected to a horizontal frame, and the horizontal frame is of an “n”-shaped structure, longitudinal frames of the horizontal frame are respectively rotatably connected to the horizontal rotating shaft D. and a rack D is fixed to the bottom of a lateral frame of the horizontal frame: the saw blade is located in the area of the gap between the two moxa-moxibustion strip clamps A. and a minimum distance between the edge of the saw blade and the axis center of the rotating clamp plate B is less than a minimum distance between the hole wall of the through hole A and the axis center of the rotating clamp plate B.

A still further improved solution of the present invention is that the horizontal rotating shaft D is driven by a driving motor D, and the driving motor D is fixed on the horizontal frame.

A still further improved solution of the present invention is that the rotating clamp plates C are located on the side of the rotating clamp plate B facing away from the rotating clamp plates A and below the cutting device, the bottom of each rotating clamp plate C is coaxially provided with a support column, the rotating clamp plate C rotates horizontally around the support column, a plurality of moxa-moxibustion strip clamps B are uniformly distributed on the edge of an upper surface of the rotating clamp plate C, the moxa-moxibustion strip clamp B includes two movable clamping sheets B on the top of a base which move toward or away from each other by clamping pistons C, the opposite end surfaces of the movable clamping sheets B are respectively provided with arc-surfaced grooves B, when the two movable clamping sheets B are attached, the arc-surfaced grooves B of the two corresponding movable clamping sheets B constitute a through hole B matching the moxa-moxibustion strip, and the clamping pistons C are respectively fixedly connected to the corresponding base.

A still further improved solution of the present invention is that the rotating clamp plate C is driven by a driving motor E, and the driving motor E is fixed in the support column.

A still further improved solution of the present invention is that when one of the moxa-moxibustion strip clamp groups on the rotating clamp plate B corresponds to one of the groups of clamping blocks on the rotating clamp plates A, another moxa-moxibustion strip clamp group corresponds to one of the moxa-moxibustion strip clamps B on the rotating clamp plates C.

A still further improved solution of the present invention is that the base mounting device includes a gluing machine and a mounting device, and when one of the moxa-moxibustion strip clamps B on the rotating clamp plates C corresponds to one of the moxa-moxibustion strip clamp groups on the rotating clamp plate B, two another moxa-moxibustion strip clamps B are respectively located at the position of the gluing machine and the position of the mounting device.

A still further improved solution of the present invention is that the mounting device includes base dropping tubes, a lower portion of an end surface A on a side of each base dropping tube facing the rotating clamp plate C is provided with a notch A, a lower portion of an end surface B on a side of the base dropping tube facing away from the rotating clamp plate C is provided with a notch B, the bottom of the interior of the base dropping tube is provided with a material receiving block matching an outer surface of a moxa-moxibustion strip base, the bottom of the material receiving block is vertically movably connected by a lifting piston B, the side of the base dropping tube facing away from the rotating clamp plate C is provided with a material pushing device, the material pushing device includes a material pushing head matching the inner wall of the moxa-moxibustion strip base, one end of the material pushing head facing away from the base dropping tube is connected to a material pushing piston A, the material pushing piston A is connected to a material pushing piston B, and the material pushing piston B is fixed to a rack E.

A still further improved solution of the present invention is that when a piston rod E of the lifting piston B extends upwardly out of the lifting piston B by a maximum stroke, the height of the moxa-moxibustion strip base located on the material receiving block matches the height of the moxa-moxibustion strip clamped by the moxa-moxibustion strip clamp B, and when the piston rod E retracts downwardly into the lifting piston B by the maximum stroke, the highest point of the material receiving block is lower than the lowest point of the moxa-moxibustion strip base.

A still further improved solution of the present invention is that the height of the top edge of the notch A is greater than the maximum height of the moxa-moxibustion strip base matching the height of the moxa-moxibustion strip clamped by the moxa-moxibustion strip clamp B.

A still further improved solution of the present invention is that when a piston rod F of the material pushing piston A retracts into the material pushing piston A by a maximum stroke and when a piston rod G of the material pushing piston B retracts into the material pushing piston B by a maximum stroke, the material pushing head is located on the outside of the base dropping tube; when the piston rod F of the material pushing piston A retracts into the material pushing piston A by the maximum stroke and when the piston rod G of the material pushing piston B extends out of the material pushing piston B by the maximum stroke, the material pushing head is attached to the inner wall of the moxa-moxibustion strip base located on the material receiving block; when the piston rod F of the material pushing piston A extends out of the material pushing piston A by the maximum stroke and when the piston rod G of the material pushing piston B extends out of the material pushing piston B by the maximum stroke, the material pushing head matches and combines a mounting slot of the moxa-moxibustion strip base with the wrapping part of the moxa-moxibustion strip clamped by the moxa-moxibustion strip clamp B corresponding to the mounting device.

A still further improved solution of the present invention is that one end of the mounting slot away from the rotating clamp plate C is provided with a surrounding wall inwardly, and an inner hole of the surrounding wall forms a vent hole.

A still further improved solution of the present invention is that two side surfaces, corresponding to the end surface B, in the base dropping tube are respectively provided with sliding slots matching a flange at the bottom of the moxa-moxibustion strip base.

A still further improved solution of the present invention is that one end of the flange facing away from the rotating clamp plate C is provided with a double-sided adhesive layer.

A still further improved solution of the present invention is that the material receiving block is provided with a flange slot corresponding to the flange of the moxa-moxibustion strip base.

A still further improved solution of the present invention is that the discharging conveying device includes conveying belts B located below positions between the rotating clamp plates C and the base dropping tubes, and two sides of each conveying belt B are provided with racks F.

A still further improved solution of the present invention is that the conveying belt B is driven by a driving motor F, and the driving motor F is fixed on the rack F.

A still further improved solution of the present invention is that the top of the rack F on the side of the conveying belt B close to the rotating clamp plate C is fixedly provided with a material retaining vertical plate at a position corresponding to the base dropping tube.

The beneficial effects of the present invention are as follows:

first, the full-automatic production line for moxa-moxibustion strips of the present invention implements automated production of extruding, sectioning, wrapping, base mounting and discharging of moxa-moxibustion strips, and improves the production efficiency while ensuring the production quality:

second, in the full-automatic production line for moxa-moxibustion strips of the present invention, the material holder is simple in structure, and by means of the function of the material holder, the drop height difference of moxa-moxibustion strip sections is reduced, the moxa-moxibustion strip sections are prevented from being damaged during dropping after sectioning, moreover, the moxa-moxibustion strip sections in the material holder can be automatically transferred to the conveying belt A for convenience of subsequent production of moxa-moxibustion strips;

third, in the full-automatic production line for moxa-moxibustion strips of the present invention, by means of the function of moxa-moxibustion strip cells disposed on the conveying belt, the moxa-moxibustion strip sections are prevented from random rolling during the conveyance of the conveying belt A, thereby ensuring that rotating clamp plates A can clamp the moxa-moxibustion strip sections placed on the conveying belt A;

fourth, in the full-automatic production line for moxa-moxibustion strips of the present invention, two ends of the moxa-moxibustion strip section are clamped by the rotating clamp plates A, so as to facilitate the wrapping the moxa-moxibustion strip section by the wrapping device;

fifth, in the full-automatic production line for moxa-moxibustion strips of the present invention, by means of the function of the rotating clamp plate B, a wrapping part of the moxa-moxibustion strip section is clamped, which can not only continue to apply an action force on the wrapping part, thereby improving the wrapping and fixing effect of the wrapping part and the moxa-moxibustion strip section, but also the clamping position of the rotating clamp plate B is close to two sides of a cutting device, ensuring that a saw blade does not damage other parts of the moxa-moxibustion strip section, and ensuring the quality of sawing; and

sixth, in the full-automatic production line for moxa-moxibustion strips of the present invention, the automated mounting of the moxa-moxibustion strips to bases is implemented by a base mounting device, which not only improves the production efficiency, but also ensure the mounting quality of the moxa-moxibustion strips to the bases.

### BRIEF DESCRIPTION OF THE DRAWINGS

FIG. 1 is a schematic top view of the present application.

FIG. 2 is a schematic front view of the present application.

FIG. 3 is a schematic enlarged front view at the position of a sectioning device when a piston rod A of a lifting piston A extends upwardly by a maximum stroke.

### DETAILED DESCRIPTION

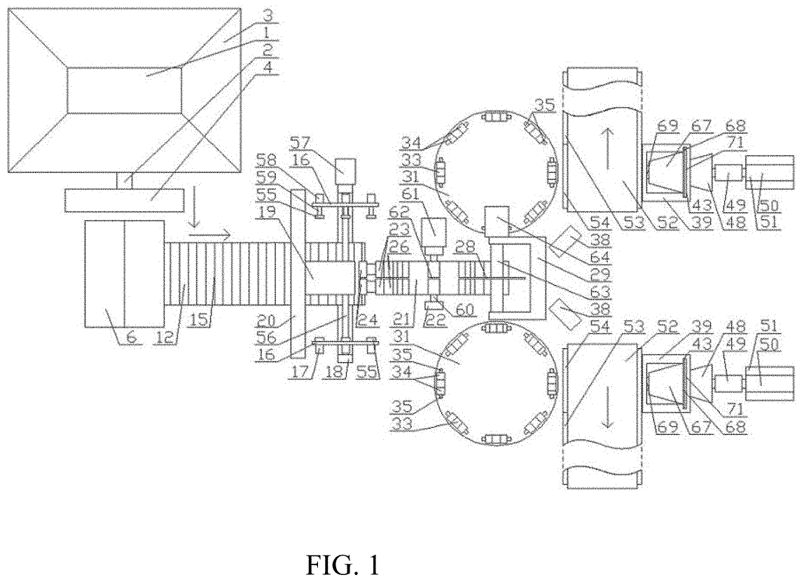

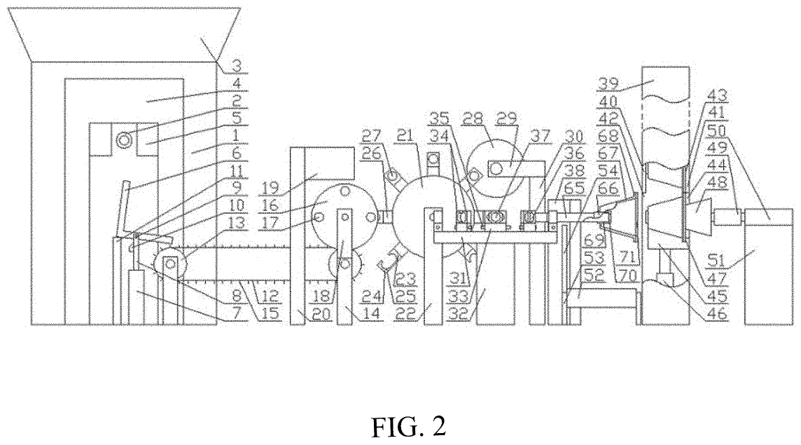

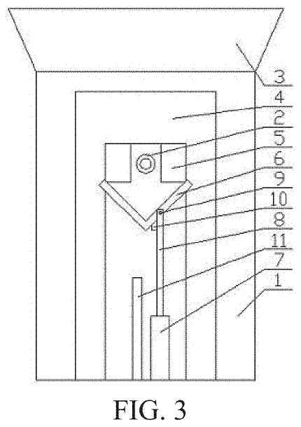

It can be known from FIGS. 1-3 that the present invention sequentially includes a strip extruder 1, a sectioning device, a wrapping device 19, a cutting device, a base mounting device, and a discharging conveying device, where the sectioning device is disposed at the tail end of an extrusion tube 2 of the strip extruder 1 and is connected to rotating clamp plates A 16 by a transfer conveying device, the rotating clamp plates A 16 pass the wrapping device 19 and are then connected to a rotating clamp plate B 21, the rotating clamp plate B 21 passes the cutting device and is then connected to rotating clamp plates C 31, and the rotating clamp plates C 31 sequentially pass the base mounting device and the discharging conveying device.

The edge of a feeding port of the strip extruder 1 is provided with a flaring material guide surrounding wall 3.

The sectioning device includes an “n”-shaped support 4, the extrusion tube 2 is located within the range of the “n”-shaped support 4, and cutters 5 for cutting a strip extruded from the extrusion tube 2 are movably connected to the inner side of the “n”-shaped support 4 at positions corresponding to the extrusion tube 2.

There are two cutters 5, which are respectively located on two sides of the extrusion tube 2, and the planes where the opposite end surfaces of the two cutters 5 are located are a same plane.

The transfer conveying device sequentially includes a material holder 6 disposed along the direction of the extrusion tube 2 and a conveying belt A 12, the material holder 6 is located on a side of the sectioning device facing away from the strip extruder 1 and the material holder 6 is located below the extrusion tube 2, and the material holder 6 is connected to the rotating clamp plates A 16 by the conveying belt A 12.

The cross section of the material holder 6 is a “V”-shaped structure having an upward opening, an end surface of a side of the material holder 6 facing the conveying belt A 12 is connected to a piston rod A 8 of a lifting piston A 7, the material holder 6 is connected to the piston rod A 8 swingably around a horizontal rotating shaft A 9, a side of the lifting piston A 7 facing away from the conveying belt A 12 is further provided with a limiting vertical plate 11, and a side of the piston rod A 8 facing away from the conveying belt A 12 is provided with a limiting block 10.

When the piston rod A 8 drives the material holder 6 to move downward until the material holder 6 is in contact with the limiting vertical plate 11, as the piston rod A 8 drives the material holder 6 to continue descending, because the limiting vertical plate 11 limits the position of the material holder 6 on the side of the lifting piston A 7 facing away from the conveying belt A 12, the material holder 6 is turned toward a direction facing the conveying belt A 12; when the piston rod A 8 drives the material holder 6 to move upward, because the center of gravity of the material holder 6 is on the side of the lifting piston A 7 facing away from the conveying belt A 12, the material holder 6 is turned toward a direction facing away from the conveying belt A 12; and when the material holder 6 is driven by the piston rod A 8 to rise to be separated from the limiting vertical plate 11, the material holder 6 is in contact with the limiting block 10, and the material holder 6 is kept horizontal in this case.

The conveying belt A 12 is driven by horizontal transmission rollers 13, two ends of each transmission roller 13 are respectively rotatably connected to racks A 14, a plurality of vertical bars 15 are uniformly distributed on an outer surface of the conveying belt A 12, the vertical bars 15 are arranged in a direction parallel to the extrusion tube 2, a moxa-moxibustion strip cell is formed between two adjacent vertical bars 15 and the width of the moxa-moxibustion strip cell is greater than or equal to the diameter of a moxa-moxibustion strip 65 extruded from the extrusion tube 2, and the width of the conveying belt A 12 is less than the length of a moxa-moxibustion strip section obtained after sectioning by the sectioning device.

A driving motor A drives the transmission roller 13, and the driving motor A is fixed to the rack A 14.

“L”-shaped supports 18 disposed outwardly are respectively fixed to the tops of the racks A 14 on a side of the conveying belt A 12 away from the material holder 6, a cross rod of each “L”-shaped support 18 is located at the lower portion and fixed to the rack A 14, the inner sides of the upper ends of vertical rods of the “L”-shaped supports 18 are connected by a horizontal rotating shaft B 56, the horizontal rotating shaft B 56 is rotatably connected to the “L”-shaped supports 18, the rotating clamp plates A 16 are respectively fixed to two ends of the horizontal rotating shaft B 56 and located on the inner sides of the “L”-shaped supports 18, a plurality of clamping blocks (55) are respectively correspondingly disposed on opposite side end surfaces of the rotating clamp plates A 16, the clamping blocks 55 are uniformly distributed with the horizontal rotating shaft B 56 as a center and the clamping blocks 55 are rotatably respectively connected to the respective rotating clamp plates A 16, the clamping blocks 55 on one of the rotating clamp plates A 16 are respectively fixed to output shafts of driving motors M 17, the driving motors M 17 are fixed on an outer end surface of the rotating clamp plate A 16, and the clamping blocks 55 on the other of the rotating clamp plates A 16 are rotatably connected to end portions of piston rods B 59 of clamping pistons A 58.

When the piston rod B 59 retracts into the clamping piston A 58 by a maximum stroke, the spacing between the clamping block 55 on the piston rod B 58 and the corresponding clamping block 55 on the other rotating clamp plate A 16 is greater than the length of the moxa-moxibustion strip section obtained after sectioning by the sectioning device, and the clamp blocks 55 are respectively located outside the two ends of the moxa-moxibustion strip section conveyed on the conveying belt A 12; when the piston rod B 59 extends out of the clamping piston A 58 by the maximum stroke, the spacing between the clamping block 55 on the piston rod B 58 and the corresponding clamping block 55 on the other rotating clamp plate A 16 is less than the length of the moxa-moxibustion strip section obtained after sectioning by the sectioning device.

The horizontal rotating shaft B 56 is driven by a driving motor B 57, and the driving motor B 57 is fixed on the “L”-shaped support 18.

The wrapping device 19 is located above a position between the two rotating clamp plates A 16 by means of a rack B 20 and is located at a midpoint position of the moxa-moxibustion strip section clamped between the corresponding clamping blocks 55; when any group of corresponding clamping blocks 55 rotate to a corresponding position of the wrapping device 19, another group of corresponding clamping blocks 55 match the moxa-moxibustion strip cells on the upper surface of the conveying belt A 12 in height, and the group of corresponding clamping blocks 55 matching the moxa-moxibustion strip cells in height are located within the ascending stroke range of the rotating clamp plates A 16.

The rack B 20 is of an “n”-shaped structure, the wrapping device 19 is fixed on a cross rod of the rack B 20, vertical rods of the rack B 20 are respectively disposed on two sides of the conveying belt A 12, and the vertical rods of the rack B 20 are located outside the moxa-moxibustion strip section conveyed on the conveying belt A 12.

The rotating clamp plate B 21 is rotatably connected to racks C 22 by a horizontal rotating shaft C 60, a plurality of moxa-moxibustion strip clamp groups are uniformly distributed on the circumferential surface of the rotating clamp plate B 21, each moxa-moxibustion strip clamp group includes two moxa-moxibustion strip clamps A arranged side by side in the direction of the axis center of the horizontal rotating shaft C 63, a gap 62 exists between the two moxa-moxibustion strip clamps A, the moxa-moxibustion strip clamp A includes a fixed clamping sheet A 23 and a movable clamping sheet A 24, the fixed clamping sheet A 23 is fixed to the rotating clamp plate B 21, the movable clamping sheet A 24 reciprocates in a direction facing or facing away from the fixed clamping sheet A 23 by a clamping piston B 26, and the clamping piston B 26 is fixed to the rotating clamp plate B 21.

An end surface of the fixed clamping sheet A 23 facing the movable clamping sheet A 24 and an end surface of the movable clamping sheet A 24 facing the fixed clamping sheet A 23 are respectively provided with arc-surfaced grooves A 25, and when the movable clamping sheet A 24 is attached to the fixed clamping sheet A 23 under the action of the clamping piston B 26, the arc-surfaced groove A 25 of the fixed clamping sheet A 23 and the arc-surfaced groove A 25 of the movable clamping sheet A 24 constitute a through hole A 27 matching a wrapping part 66 on the surface of the moxa-moxibustion strip 65.

The horizontal rotating shaft C 60 is driven by a driving motor C 61, and the driving motor C 61 is fixed on the rack C 22.

The cutting device is located above a side of the rotating clamp plate B 21 facing away from the rotating clamp plates A 16, the cutting device comprises a saw blade 28, the saw blade 28 is fixed to the middle of a horizontal rotating shaft D 63, two ends of the horizontal rotating shaft D 63 are respectively rotatably connected to a horizontal frame 29, and the horizontal frame 29 is of an “n”-shaped structure, longitudinal frames of the horizontal frame 29 are respectively rotatably connected to the horizontal rotating shaft D 63, and a rack D 30 is fixed to the bottom of a lateral frame of the horizontal frame 29: the saw blade 28 is located in the area of the gap 62 between the two moxa-moxibustion strip clamps A, and a minimum distance between the edge of the saw blade 28 and the axis center of the rotating clamp plate B 21 is less than a minimum distance between the hole wall of the through hole A 27 and the axis center of the rotating clamp plate B 21.

The horizontal rotating shaft D 63 is driven by a driving motor D 64, and the driving motor D 64 is fixed on the horizontal frame 29.

The rotating clamp plates C 31 are located on the side of the rotating clamp plate B 21 facing away from the rotating clamp plates A 16 and below the cutting device, the bottom of each rotating clamp plate C 31 is coaxially provided with a support column 32, the rotating clamp plate C 31 rotates horizontally around the support column 32, a plurality of moxa-moxibustion strip clamps B 33 are uniformly distributed on the edge of an upper surface of the rotating clamp plate C 31, the moxa-moxibustion strip clamp B 33 includes two movable clamping sheets B 34 on the top of a base which move toward or away from each other by clamping pistons C 35, the opposite end surfaces of the movable clamping sheets B 34 are respectively provided with arc-surfaced grooves B 36, when the two movable clamping sheets B 34 are attached, the arc-surfaced grooves B 26 of the two corresponding movable clamping sheets B 34 constitute a through hole B 37 matching the moxa-moxibustion strip 65, and the clamping pistons C 35 are respectively fixedly connected to the corresponding base.

The rotating clamp plate C 31 is driven by a driving motor E, and the driving motor E is fixed in the support column 32.

When one of the moxa-moxibustion strip clamp groups on the rotating clamp plate B 21 corresponds to one of the groups of clamping blocks 55 on the rotating clamp plates A 16, another moxa-moxibustion strip clamp group corresponds to one of the moxa-moxibustion strip clamps B 33 on the rotating clamp plates C 31.

The base mounting device includes a gluing machine 38 and a mounting device, and when one of the moxa-moxibustion strip clamps B 33 on the rotating clamp plates C 31 corresponds to one of the moxa-moxibustion strip clamp groups on the rotating clamp plate B 21, two another moxa-moxibustion strip clamps B 33 are respectively located at the position of the gluing machine 38 and the position of the mounting device.

The mounting device includes base dropping tubes 39, a lower portion of an end surface A 40 on a side of each base dropping tube 39 facing the rotating clamp plate C 31 is provided with a notch A 42, a lower portion of an end surface B 41 on a side of the base dropping tube 39 facing away from the rotating clamp plate C 31 is provided with a notch B 44, the bottom of the interior of the base dropping tube 39 is provided with a material receiving block 45 matching an outer surface of a moxa-moxibustion strip base 67, the bottom of the material receiving block 45 is vertically movably connected by a lifting piston B 46, the side of the base dropping tube 39 facing away from the rotating clamp plate C 31 is provided with a material pushing device, the material pushing device includes a material pushing head 48 matching the inner wall of the moxa-moxibustion strip base 67, one end of the material pushing head 48 facing away from the base dropping tube 39 is connected to a material pushing piston A 49, the material pushing piston A 49 is connected to a material pushing piston B 50, and the material pushing piston B 50 is fixed to a rack E 51.

When a piston rod E of the lifting piston B 46 extends upwardly out of the lifting piston B 46 by a maximum stroke, the height of the moxa-moxibustion strip base 67 located on the material receiving block 45 matches the height of the moxa-moxibustion strip 65 clamped by the moxa-moxibustion strip clamp B 33, and when the piston rod E retracts downwardly into the lifting piston B 46 by the maximum stroke, the highest point of the material receiving block 45 is lower than the lowest point of the moxa-moxibustion strip base 67.

The height of the top edge of the notch A 42 is greater than the maximum height of the moxa-moxibustion strip base 67 matching the height of the moxa-moxibustion strip 65 clamped by the moxa-moxibustion strip clamp B 33.

When a piston rod F of the material pushing piston A 49 retracts into the material pushing piston A 49 by a maximum stroke and when a piston rod G of the material pushing piston B 50 retracts into the material pushing piston B 50 by a maximum stroke, the material pushing head 48 is located on the outside of the base dropping tube 39; when the piston rod F of the material pushing piston A 49 retracts into the material pushing piston A 49 by the maximum stroke and when the piston rod G of the material pushing piston B 50 extends out of the material pushing piston B 50 by the maximum stroke, the material pushing head 48 is attached to the inner wall of the moxa-moxibustion strip base 67 located on the material receiving block 45; when the piston rod F of the material pushing piston A 49 extends out of the material pushing piston A 49 by the maximum stroke and when the piston rod G of the material pushing piston B 50 extends out of the material pushing piston B 50 by the maximum stroke, the material pushing head 48 matches and combines a mounting slot 69 of the moxa-moxibustion strip base 67 with the wrapping part 66 of the moxa-moxibustion strip 65 clamped by the moxa-moxibustion strip clamp B 33 corresponding to the mounting device.

One end of the mounting slot 69 away from the rotating clamp plate C 31 is provided with a surrounding wall 70 inwardly, and an inner hole of the surrounding wall 70 forms a vent hole.

Two side surfaces, corresponding to the end surface B 41, in the base dropping tube 39 are respectively provided with sliding slots 43 matching a flange 68 at the bottom of the moxa-moxibustion strip base 67.

One end of the flange 68 facing away from the rotating clamp plate C 31 is provided with a double-sided adhesive layer 71.

The material receiving block 45 is provided with a flange slot 47 corresponding to the flange 68 of the moxa-moxibustion strip base 67.

The discharging conveying device includes conveying belts B 52 located below positions between the rotating clamp plates C 31 and the base dropping tubes 39, and two sides of each conveying belt B 52 are provided with racks F 53.

The conveying belt B 52 is driven by a driving motor F. and the driving motor F is fixed on the rack F 53.

The top of the rack F 53 on the side of the conveying belt B 52 close to the rotating clamp plate C 31 is fixedly provided with a material retaining vertical plate 54 at a position corresponding to the base dropping tube 39.

When the present invention is used, raw materials are poured into the feeding port of the strip extruder 1, the raw materials are mixed and extruded into strips by the strip extruder 1, and the stripes are finally extruded from the position of the extrusion tube 2; when the length of a moxa-moxibustion strip extruded from the extrusion tube 2 reaches a designated length, the cutters 5 cut the moxa-moxibustion strip extruded from the extrusion tube 2 into moxa-moxibustion strip sections, and the length of the cut moxa-moxibustion strip section is twice the length of a moxa-moxibustion strip to be produced; then the cut moxa-moxibustion strip section falls into the material holder 6 which rises to the highest position; then the lifting piston A drives the material holder 6 and the moxa-moxibustion strip section in the material holder 6 to move downward until the material holder 6 is in contact with the limiting vertical plate 11, and the limiting vertical plate 11 enables the material holder 6 to be turned toward the conveying belt A 12 side to enable the moxa-moxibustion strip section in the material holder 6 to roll into the moxa-moxibustion strip cell of the conveying belt A 12, so that the moxa-moxibustion strip section is conveyed along the conveying belt A 12 towards the rotating clamp plates A 16, and when the moxa-moxibustion strip section passes through a pair of clamping blocks 55, at positions corresponding to the moxa-moxibustion strip cell in height, of the rotating clamp plates A 16, the conveying belt A 12 stops conveying, the clamping piston A 58 drives one of the clamping blocks 55 to clamp the moxa-moxibustion strip section in the moxa-moxibustion strip cell, and when the rotating clamp plate A 16 rotate, the moxa-moxibustion strip section clamped by the clamping block 55 leaves the moxa-moxibustion strip cell; when the moxa-moxibustion strip section clamped by the clamping block 55 leaves the moxa-moxibustion strip cell, the conveying belt A 12 continues to move forward; when the moxa-moxibustion strip section clamped by the clamping block 55 rotates upward with the action of the rotating clamp plate A 16 to a position corresponding to the wrapping device 19, the rotating clamp plate A 16 stops rotating, in this case, the wrapping device 19 wraps the central part of the moxa-moxibustion strip section clamped by the clamp block 55 with a wrapping layer 66, and the wrapping layer 66 is made of aluminum foil, the moxa-moxibustion strip section wrapped with the wrapping layer 66 continues to rotate forward under the rotation of the rotating clamp plate A 16 until the next moxa-moxibustion strip section is just located at the position of the wrapping device 19 for wrapping, and the rotating clamp plate A 16 stops rotating again; moreover, with the rotation of the rotating clamp plate B 21, when one of the moxa-moxibustion strip clamp groups on the rotating clamp plate B 21 rotates to a position corresponding to the moxa-moxibustion strip section wrapped with the wrapping layer 66, the moxa-moxibustion strip section wrapped with the wrapping layer 66 is located between the fixed clamping sheet A 23 and the movable clamping sheet A 24 of the moxa-moxibustion strip clamp group in this case, and the fixed clamping sheet A 23 and the movable clamping sheet A 24 correspond exactly to the position of the wrapping layer 66 of the moxa-moxibustion strip section, in this case, the clamping piston B 26 drives the movable clamping sheet A 24 to clamp the moxa-moxibustion strip section wrapped with the wrapping layer 66 between the fixed clamping sheet A 23 and the movable clamping sheet A 24, and the clamping piston A 58 drives the clamping block 55 to release the moxa-moxibustion strip section wrapped with the wrapping layer 66; then the moxa-moxibustion strip section wrapped with the wrapping layer 66 rotates with the rotation of the rotating clamp plate B 21, and when the moxa-moxibustion strip section wrapped with the wrapping layer 66 passes the saw blade 28, the moxa-moxibustion strip section wrapped with the wrapping layer 66 is sawed into two moxa-moxibustion strips 65 that conform to the production requirements; moreover, the two moxa-moxibustion strips 65 continue to rotate with the rotation of the rotating clamp plate B 21 to correspond to one of the moxa-moxibustion strip clamps B 33 on the rotating clamp plate C 31, and in this case, the clamping piston C 35 drives the movable clamping sheets B 34 to fix the end of the moxa-moxibustion strip 65 away from the wrapping layer 66, and the clamping piston B 26 drives the movable clamping sheet B 24 to release the end of the wrapping layer 66 of the moxa-moxibustion strip 65; then the rotating clamp plate C 31 drives the moxa-moxibustion strip clamp B 33 which clamps the moxa-moxibustion strip 65 to rotate to a work position corresponding to the gluing device 38, and then the rotating clamp plate C 31 stops rotating, waits for the gluing device 38 to fully coat the surface of the wrapping layer 66 of the moxa-moxibustion strip 65 with glue, and then continues to rotate forward: when the moxa-moxibustion strip 65 coated with glue is rotated to the position of the mounting device under the action of the rotating clamp plate C 31, the rotating clamp plate C 31 stops rotating, in this case, the material pushing piston B 50 pushes the material pushing head 48 and the moxa-moxibustion strip base 67 together out of the base dropping tube 39, the mounting slot 69 of the base 67 is attached and bonded to the wrapping layer 66 of the moxa-moxibustion strip 65, and the extended state of the material pushing piston B 50 is kept for a certain period of time, so that there is enough time for the wrapping layer 66 of the moxa-moxibustion strip 65 and the mounting slot 69 to be bonded: then the lifting piston B 46 drives the material receiving block 45 up by a maximum stroke, and then the material pushing piston A 49 and the material pushing piston B 50 both drive the material pushing head 48 to move toward a direction away from the rotating clamp plate C 31 by a maximum stroke; when the material pushing head 48 leaves the base dropping tube 39, the moxa-moxibustion strip base 67 at the lowest point of the base dropping tube 39 slides down on the material receiving block 45 under the action of gravity, then the material pushing piston A 49 drives the material pushing head 48 to extend into the moxa-moxibustion strip base 67, and then the lifting piston B 46 drives the material receiving block 45 to move downward by a maximum stroke, so that a moxa-moxibustion strip base is ready for mounting next moxa-moxibustion strip 65; at the same time, when the material pushing head 48 leaves the moxa-moxibustion strip base 67 fixed to the moxa-moxibustion strip 65, the moxa-moxibustion strip clamp B 33 at this position releases the moxa-moxibustion strip 65 with the moxa-moxibustion strip base 67 fixed, then the moxa-moxibustion strip 65 with the moxa-moxibustion strip base 67 fixed falls off under the action of gravity, and because the center of gravity of the moxa-moxibustion strip 65 with the moxa-moxibustion strip base 67 fixed is located above the conveying belt B 52, under the action of gravity, the moxa-moxibustion strip 65 with the moxa-moxibustion strip base 67 fixed rotates around the material retaining vertical plate 54 to a vertical state, the moxa-moxibustion strip base 67 is made to be in contact with the conveying belt B 52, and discharging is carried out under the conveyance of the conveying belt B 52.

1. A full-automatic production line for moxa-moxibustion strips, sequentially comprising a strip extruder, a sectioning device, a wrapping device, a cutting device, a base mounting device, and a discharging conveying device, wherein the sectioning device is disposed at the tail end of an extrusion tube of the strip extruder and is connected to rotating clamp plates A by a transfer conveying device, the rotating clamp plates A pass the wrapping device and are then connected to a rotating clamp plate B, the rotating clamp plate B passes the cutting device and is then connected to rotating clamp plates C, and the rotating clamp plates C sequentially pass the base mounting device and the discharging conveying device.

2. The full-automatic production line for moxa-moxibustion strips according to claim 1, wherein the transfer conveying device sequentially comprises a material holder disposed along the direction of the extrusion tube and a conveying belt A, the material holder is located on a side of the sectioning device facing away from the strip extruder and the material holder is located below the extrusion tube, and the material holder is connected to the rotating clamp plates A by the conveying belt A.

3. The full-automatic production line for moxa-moxibustion strips according to claim 2, wherein the cross section of the material holder is a “V”-shaped structure having an upward opening, an end surface of a side of the material holder facing the conveying belt A is connected to a piston rod A of a lifting piston A, the material holder is connected to the piston rod A swingably around a horizontal rotating shaft A, a side of the lifting piston A facing away from the conveying belt A is further provided with a limiting vertical plate, and a side of the piston rod A facing away from the conveying belt A is provided with a limiting block; when the piston rod A drives the material holder to move downward until the material holder is in contact with the limiting vertical plate, as the piston rod A drives the material holder to continue descending, because the limiting vertical plate limits the position of the material holder on the side of the lifting piston A facing away from the conveying belt A, the material holder is turned toward a direction facing the conveying belt A; when the piston rod A drives the material holder to move upward, because the center of gravity of the material holder is on the side of the lifting piston A facing away from the conveying belt A, the material holder is turned toward a direction facing away from the conveying belt A; and when the material holder is driven by the piston rod A to rise to be separated from the limiting vertical plate, the material holder is in contact with the limiting block, and the material holder is kept horizontal in this case.

4. The full-automatic production line for moxa-moxibustion strips according to claim 2, wherein the conveying belt A is driven by horizontal transmission rollers, two ends of each transmission roller are respectively rotatably connected to racks A, a plurality of vertical bars are uniformly distributed on an outer surface of the conveying belt A, the vertical bars are arranged in a direction parallel to the extrusion tube, a moxa-moxibustion strip cell is formed between two adjacent vertical bars and the width of the moxa-moxibustion strip cell is greater than or equal to the diameter of a moxa-moxibustion strip extruded from the extrusion tube, and the width of the conveying belt A is less than the length of a moxa-moxibustion strip section obtained after sectioning by the sectioning device; “L”-shaped supports disposed outwardly are respectively fixed to the tops of the racks A on a side of the conveying belt A away from the material holder, a cross rod of each “L”-shaped support is located at the lower portion and fixed to the rack A, the inner sides of the upper ends of vertical rods of the “L”-shaped supports are connected by a horizontal rotating shaft B, the horizontal rotating shaft B is rotatably connected to the “L”-shaped supports, the rotating clamp plates A are respectively fixed to two ends of the horizontal rotating shaft B and located on the inner sides of the “L”-shaped supports, a plurality of clamping blocks are respectively correspondingly disposed on opposite side end surfaces of the rotating clamp plates A, the clamping blocks are uniformly distributed with the horizontal rotating shaft B as a center and the clamping blocks are respectively rotatably connected to the respective rotating clamp plates A, the clamping blocks on one of the rotating clamp plates A are respectively fixed to output shafts of driving motors M, the driving motors M are fixed on an outer end surface of the rotating clamp plate A, and the clamping blocks on the other of the rotating clamp plates A are rotatably connected to end portions of piston rods B of clamping pistons A; when the piston rod B retracts into the clamping piston A by a maximum stroke, the spacing between the clamping block on the piston rod B and the corresponding clamping block on the other rotating clamp plate A is greater than the length of the moxa-moxibustion strip section obtained after sectioning by the sectioning device, and the clamp blocks are respectively located outside the two ends of the moxa-moxibustion strip section conveyed on the conveying belt A; when the piston rod B extends out of the clamping piston A by the maximum stroke, the spacing between the clamping block on the piston rod B and the corresponding clamping block on the other rotating clamp plate A is less than the length of the moxa-moxibustion strip section obtained after sectioning by the sectioning device.

5. The full-automatic production line for moxa-moxibustion strips according to claim 4, wherein the rotating clamp plate B is rotatably connected to racks C by a horizontal rotating shaft C, a plurality of moxa-moxibustion strip clamp groups are uniformly distributed on the circumferential surface of the rotating clamp plate B, each moxa-moxibustion strip clamp group comprises two moxa-moxibustion strip clamps A arranged side by side in the direction of the axis center of the horizontal rotating shaft C, a gap exists between the two moxa-moxibustion strip clamps A, the moxa-moxibustion strip clamp A comprises a fixed clamping sheet A and a movable clamping sheet A, the fixed clamping sheet A is fixed to the rotating clamp plate B, the movable clamping sheet A reciprocates in a direction facing or facing away from the fixed clamping sheet A by a clamping piston B, and the clamping piston B is fixed to the rotating clamp plate B.

6. The full-automatic production line for moxa-moxibustion strips according to claim 5, wherein the cutting device is located above a side of the rotating clamp plate B facing away from the rotating clamp plates A, the cutting device comprises a saw blade, the saw blade is fixed to the middle of a horizontal rotating shaft D, two ends of the horizontal rotating shaft D are respectively rotatably connected to a horizontal frame, and the horizontal frame is of an “n”-shaped structure, longitudinal frames of the horizontal frame are respectively rotatably connected to the horizontal rotating shaft D, and a rack D is fixed to the bottom of a lateral frame of the horizontal frame; the saw blade is located in the area of the gap between the two moxa-moxibustion strip clamps A, and a minimum distance between the edge of the saw blade and the axis center of the rotating clamp plate B is less than a minimum distance between the hole wall of a through hole A and the axis center of the rotating clamp plate B.

7. The full-automatic production line for moxa-moxibustion strips according to claim 6, wherein the rotating clamp plates C are located on the side of the rotating clamp plate B facing away from the rotating clamp plates A and below the cutting device, the bottom of each rotating clamp plate C is coaxially provided with a support column, the rotating clamp plate C rotates horizontally around the support column, a plurality of moxa-moxibustion strip clamps B are uniformly distributed on the edge of an upper surface of the rotating clamp plate C, the moxa-moxibustion strip clamp B comprises two movable clamping sheets B on the top of a base which move toward or away from each other by clamping pistons C, the opposite end surfaces of the movable clamping sheets B are respectively provided with arc-surfaced grooves B, when the two movable clamping sheets B are attached, the arc-surfaced grooves B of the two corresponding movable clamping sheets B constitute a through hole B matching the moxa-moxibustion strip, and the clamping pistons C are respectively fixedly connected to the corresponding base.

8. The full-automatic production line for moxa-moxibustion strips according to claim 7, wherein the mounting device comprises base dropping tubes, a lower portion of an end surface A on a side of each base dropping tube facing the rotating clamp plate C is provided with a notch A, a lower portion of an end surface B on a side of the base dropping tube facing away from the rotating clamp plate C is provided with a notch B, the bottom of the interior of the base dropping tube is provided with a material receiving block matching an outer surface of a moxa-moxibustion strip base, the bottom of the material receiving block is vertically movably connected by a lifting piston B, the side of the base dropping tube facing away from the rotating clamp plate C is provided with a material pushing device, the material pushing device comprises a material pushing head matching the inner wall of the moxa-moxibustion strip base, one end of the material pushing head facing away from the base dropping tube is connected to a material pushing piston A, the material pushing piston A is connected to a material pushing piston B, and the material pushing piston B is fixed to a rack E; when a piston rod E of the lifting piston B extends upwardly out of the lifting piston B by a maximum stroke, the height of the moxa-moxibustion strip base located on the material receiving block matches the height of the moxa-moxibustion strip clamped by the moxa-moxibustion strip clamp B, and when the piston rod E retracts downwardly into the lifting piston B by the maximum stroke, the highest point of the material receiving block is lower than the lowest point of the moxa-moxibustion strip base; the height of the top edge of the notch A is greater than the maximum height of the moxa-moxibustion strip base matching the height of the moxa-moxibustion strip clamped by the moxa-moxibustion strip clamp B.

9. The full-automatic production line for moxa-moxibustion strips according to claim 8, wherein when a piston rod F of the material pushing piston A retracts into the material pushing piston A by a maximum stroke and when a piston rod G of the material pushing piston B retracts into the material pushing piston B by a maximum stroke, the material pushing head is located on the outside of the base dropping tube; when the piston rod F of the material pushing piston A retracts into the material pushing piston A by the maximum stroke and when the piston rod G of the material pushing piston B extends out of the material pushing piston B by the maximum stroke, the material pushing head is attached to the inner wall of the moxa-moxibustion strip base located on the material receiving block; when the piston rod F of the material pushing piston A extends out of the material pushing piston A by the maximum stroke and when the piston rod G of the material pushing piston B extends out of the material pushing piston B by the maximum stroke, the material pushing head matches and combines a mounting slot of the moxa-moxibustion strip base with a wrapping part of the moxa-moxibustion strip clamped by the moxa-moxibustion strip clamp B corresponding to the mounting device.

10. The full-automatic production line for moxa-moxibustion strips according to claim 8, wherein the discharging conveying device comprises conveying belts B located below positions between the rotating clamp plates C and the base dropping tubes, and two sides of each conveying belt B are provided with racks F; the top of the rack F on the side of the conveying belt B close to the rotating clamp plate C is fixedly provided with a material retaining vertical plate at a position corresponding to the base dropping tube.
